(19) United States
(12) Patent Application Publication
(10) Pub. No.: US 2011/0300351 A1
(43) Pub. Date: Dec. 8, 2011

(54) METHOD FOR PRODUCING DECORATIVE PAPER AND DECORATIVE PAPER

(75) Inventors: Kimmo Suur-Nuuja, Arnsberg (DE); Heinz Kleineruesskamp, Arnsberg (DE)

(73) Assignee: OKT GERMANY GMBH, STEMWEDE (DE)

(21) Appl. No.: 13/147,865

(22) PCT Filed: Feb. 3, 2010
(86) PCT No.: PCT/EP2010/000639

§ 371 Date: Aug. 25, 2011

(30) Foreign Application Priority Data
Feb. 4, 2009 (DE) 10 2009 007 544.5

(51) Int. Cl. B05D 1/36; B32B 3/18

(52) U.S. Cl. 428/204; 427/258

(57) ABSTRACT

A method reduces the needed input of resin during an impregnation of decorative papers. As a result of the application of an aliphatic anionic polyurethane dispersion containing polycarbonate following printing, the quantity of resin absorbed in the impregnation is reduced by the capillary action of the paper fibers. At the same time, the light fastness of the printed or unprinted decorative papers is increased. The level of gloss of the pressed paper following application to a paper printed with metal effect ink is enhanced. The tear resistance of a decorative paper is improved and the growth during the impregnation is reduced considerably.

The present invention relates to a method for producing decorative paper and to decorative paper.

Decorative coated materials, so-called decorative papers, are special papers for surface finishing wood materials. Due to the high visual standard, the most stringent requirements apply to the decorative paper. The paper must have particularly good formation, smoothness and dimensional stability to be able to be optimally printed. The synthetic resin impregnation necessary for processing requires uniform penetration of the resin into the paper. The impregnation with subsequent pressing mainly serves to reduce the sensitivity of the surface with respect to mechanical, thermal and chemical stresses (e.g. abrasion, scratching, water, solvents, water vapor and solvent vapors).

There is also a demand to reduce the resin absorbing capability of the paper. Basically two ways of achieving this have become known.

On the one hand the attempt has been made to compact the decorative papers and thus to leave a smaller number of cavities in the paper in which resin can be embedded. This effect is mentioned, for example, already in the introductory portion to DE 101 34 302 C1. However, this method has not been able to penetrate the market significantly.

Another way to reduce the resin-receiving capability of decorative papers has become known. After paper production, it is possible to apply a so-called glue line to the decorative papers. This is preferably achieved by applying an acrylate dispersion to the surfaces offline or online. By these means, the surface of the paper is partially sealed and it is harder for the resin to penetrate the paper. It is also conceivable to thus reduce the capillary action of the paper fibers.

The latter technique, in particular, is only used for papers that are not (or not yet) printed. Thus the printer must decide prior to printing whether or not to use a paper with reduced resin-absorbing capability (resin-saving paper).

This is where the present invention comes in and has the object to propose a method for producing decorative paper, wherein prior selection of the paper, in particular a “resin-saving paper” or a “non-resin-saving paper” is not necessary.

According to the present invention the object is achieved by a method with the characterizing features of claim 1. By applying an aliphatic, polycarbonate-containing anionic polyurethane dispersion to the paper after printing, both conventional and resin-saving paper can be used for producing decorative papers. Consequently and as a new concept, in particular, with the method described here, the adjustment of resin saving is carried out after printing using an aliphatic, polycarbonate-containing anionic polyurethane dispersion. Such dispersions have not yet been used in conjunction with decorative papers. By applying them after printing, the printer's flexibility in selecting the printing base papers is increased. A precondition in paper manufacture is always that a minimum quantity be produced in each configuration. This results in minimum purchase orders limiting the flexibility of the printer.

While the use of polyurethanes as lacquer systems on printed or non-printed papers is known, unlike the invention described here, they are lacquers to which a hardener must be added. These lacquer surfaces are the barrier against the environment; the papers are not further impregnated or otherwise surface finished, but are laminated on top of materials. This kind of procedure is not proposed here.

The light fastness of the decorative papers produced according to the present invention is improved as a further advantageous side effect of the proposed method. To improve the light fastness of decorative papers, according to the state of the art, overlays, for example, that also have an acrylate dispersion applied to them, are deposited on the decorative papers prior to pressing. These procedures are not necessary with the proposed method.

Further advantageous embodiments of the proposed method can be derived, in particular from the features of the dependent claims.

A further object of the present invention is to propose a decorative paper having increased light fastness and being able to be produced in a cost-effective manner.

According to the present invention, this method is achieved by a decorative paper having the characterizing features of claim 11. The decorative paper comprising at least one paper core, a printed layer, and an aliphatic, polycarbonate-containing anionic polyurethane dispersion embedded in the paper core, makes it possible for a decorative paper to be provided having increased light fastness and which can be produced in a cost-effective manner, since both “resin-saving paper” and “non-resin-saving paper” can be used as an initial material for the paper core.

Further advantageous embodiments of the suggested decorative paper can be derived, in particular from the features of the dependent claims.

Further features and advantages of the present invention will become obvious with reference to the following description of preferred exemplary embodiments with reference to the accompanying tables and figures, wherein:

Tab. 1 is a material safety data sheet relating to BAYHYDROL® XP 2606 (page 1 of 5);

Tab. 2 is a material safety data sheet relating to BAYHYDROL® XP 2606 (page 2 of 5);

Tab. 3 is a material safety data sheet relating to BAYHYDROL® XP 2606 (page 3 of 5);

Tab. 4 is a material safety data sheet relating to BAYHYDROL® XP 2606 (page 4 of 5);

Tab. 5 is a material safety data sheet relating to BAYHYDROL® XP 2606 (page 5 of 5);

Tab. 6 is a product data sheet relating to BAYHYDROL® (page 1 of 3);

Tab. 7 is a product data sheet relating to BAYHYDROL® (page 2 of 3);

Tab. 8 is a product data sheet relating to BAYHYDROL® (page 3 of 3);

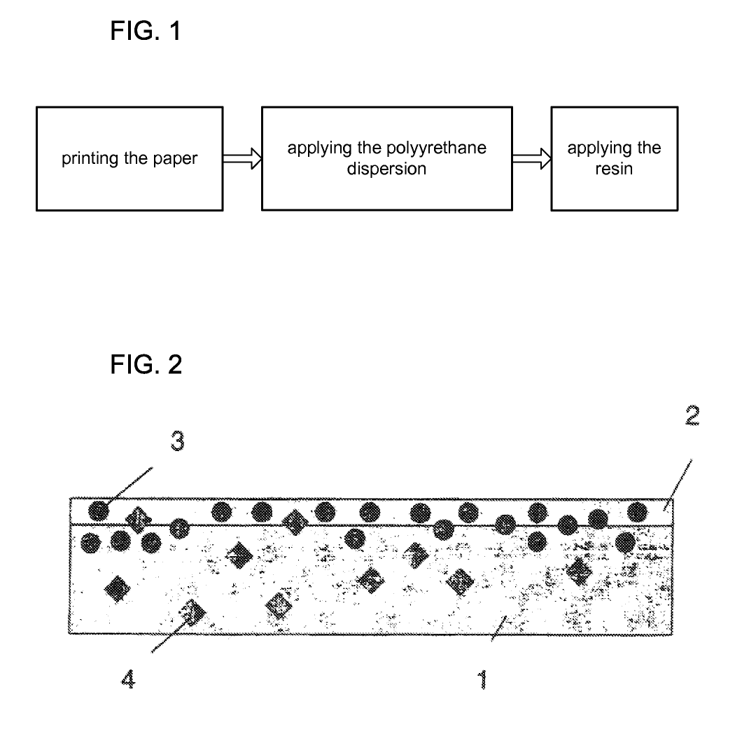

FIG. 1 is a schematic diagram of the method according to the present invention;

FIG. 2 is a schematic cross-sectional view of a decorative paper according to the present invention.

According to the present invention, an aliphatic, polycarbonate-containing anionic polyurethane dispersion is applied to the printed paper. This can be the product Bayhydrol® XP 2606 made by Bayer, or another comparable product (Bayhydrol® is a registered trademark of Bayer AG, 51373 Leverkusen, Germany). The polyurethane dispersion reduces the capillary action, whereby the polycarbonate causes the dispersion to adhere in the capillaries, which are thus narrowed to some extent. The pH value, important for further processing of the papers, is adjusted by the concentration of the anions. The aliphates improve the light fastness.

After application, there is no visible color shift of the printed base paper. The printing product can thus optionally be produced in the resin-saving or standard configuration, without a color adjustment becoming necessary. A color adjustment is absolutely necessary when using the well-known resin-saving papers due to the modified ink absorption during printing.

The aliphatic, polycarbonate-containing anionic polyurethane dispersion, in particular the product Bayhydrol® XP 2606, is mixed at a ratio of 25 portions to 75 portions (weight portions) of water and applied on the print with a dry weight of about 5 g/m². These parameters are typical values and can change for various papers. Application is either in the gravure printing process by means of background cylinders in the last printing stage online, or offline in another suitable method, for example in a varnishing unit.

Tables 1 to 8 show material safety data sheets, or product data sheets of an aliphatic, polycarbonate-containing anionic polyurethane dispersion, in particular a dispersion marketed under the Bayhydrol® trademark. The characteristics of an aliphatic, polycarbonate-containing anionic polyurethane dispersion preferably to be used for the suggested method according to the present invention can be derived therefrom. It should be noted that the present is only a preferred dispersion. Basically, any other aliphatic, polycarbonate-containing anionic polyurethane dispersion could, of course, also be used.

FIG. 1 is a schematic representation of the suggested method according to the present invention.

FIG. 2 is a schematic cross-sectional view of the decorative paper according to the present invention manufactured with the method according to the present invention. Essentially, the decorative paper according to the present invention comprises a paper core 1, a printed layer 2, an aliphatic, polycarbonate-containing anionic polyurethane dispersion 3 embedded in the paper core 1, and, in particular, a resin layer, or embedded resin particles 4.

The suggested method according to the present invention can be particularly advantageously used for the following exemplary applications.

Particular advantages arise in connection with the method according to the present invention, or a decorative paper according to the present invention and metal effect inks, in particular so-called mother-of-pearl inks.

One important aesthetic property of decorative designs printed with mother-of-pearl inks, is the level of gloss achieved with them. The level of gloss essentially depends on the amount of mother-of-pearl pigments applied in the mother-of-pearl ink. When printed as a single-color tint, mother-of-pearl pigments are usually fixed by means of a blend printed on top of it as a binder. The amount of pigment cannot be increased at will since the paper must retain its impregnability. Too high an amount leads to partial sealing of the surface, and the resin can only insufficiently penetrate the paper leading to impregnation faults and thus to a high amount of waste paper. On the other hand, the level of gloss depends on the flow behavior and hardening of the resin. Excessively rapid hardening leads to a low level of gloss since the resin does not flow sufficiently during pressing and adopts the (glossy) structure of the pressing sheet. In the worst case, spots are formed, which is also waste.

One approach to enhance the gloss and avoid impregnating faults has already been described in patent number EP 13 61 074 B1. By applying an alkaline solution, the flow behavior of the resin is positively influenced. The substance must be separately applied, however.

An improvement in the level of gloss can also be achieved, however, by replacing the blend for fixing the pigment by an aliphatic, polycarbonate-containing anionic polyurethane dispersion. With reference to the method steps illustrated according to claim 1, this means that printing the paper (method step i) is carried out with a mother-of-pearl-containing ink. Subsequently, the aliphatic, polycarbonate-containing anionic polyurethane dispersion is applied (method step ii). The product can be produced with one printing unit less compared to the manner described in EP 13 61 074 B1, which increases flexibility and lowers costs, e.g. energy costs.

The level of gloss of the thus produced surfaces is very high. As the case may be, a higher level of gloss can be achieved than with the substance described according to EP 13 61 074 B1. Moreover, the paper becomes less sensitive with respect to manufacturing variations during impregnation and pressing.

Particular advantages also arise in connection with the method according to the present invention, or a decorative paper according to the present invention, and the so-called flatness.

A problem with further processing of impregnated papers is that the edges of the paper rise. The person skilled in the art refers to this behavior as curling. It arises because paper cannot be fully symmetrically produced. The asymmetry is reinforced by printing one side. Curling also depends on the environmental conditions, in particular the air moisture of the room in which the paper is processed. What is desirable, however, is for the paper to be flat, i.e. a low amount of curling.

The person skilled in the art knows various methods from the state of the art to reduce curling. To minimize curling, if necessary, the room climate is made moister or the paper is moistened on its back prior to winding up or subsequent to unrolling.

Here too, the method suggested according to the present invention, or the decorative paper according to the present invention, can solve the problem. By applying an aliphatic, polycarbonate-containing anionic polyurethane dispersion on the back of the paper, the asymmetry is reduced, at least with printed papers. Properties like resin saving and increased flexibility, in particular due to the dispersion in the paper, also remain intact.

Particular advantages can also arise in connection with the method according to the present invention, or with a decorative paper according to the present invention, and the so-called opacity.

Decorative papers require sufficient opacity so that the underlying chipboard does not shine through. The opacity is derived from the amount of TiO2 integrated in the paper. If the opacity is to be increased, more TiO2 has to be integrated. This can only be achieved, however, by simultaneously increasing the basis weight, since the network of paper fibers cannot contain infinite amounts of TiO2. The paper becomes more unstable, the tear-resistance is reduced.

Here again, advantages can be achieved by means of the method suggested according to the present invention, or by the decorative paper suggested according to the present invention. TiO2 can be printed as an ink onto existing paper. This printed ink is sealed by printing an aliphatic, polycarbonate-containing anionic polyurethane dispersion on top of it. By hardening the aliphatic, polycarbonate-containing anionic polyurethane dispersion after printing, the tear-resistance of the paper is increased. A paper can be produced with the same basis weight, but having higher opacity, while simultaneously having the above-mentioned advantages.

Particular advantages can further arise in connection with the method according to the present invention, or a decorative paper according to the present invention, and paper growth.

In the manufacture of laminate flooring in particular, the growth of the paper during impregnation is a central concern. The individual panels must have the desired width. Tiles shall remain square. A particular challenge is pressing a porous structure simultaneously with the printed image. According to the state of the art, this is implemented by empirically determining the growth of the paper sheet due to the resin absorption and taking it into consideration in the printing data. Variations in the growth behavior due to variations in the paper production, lead to a considerable amount of waste. To be able to guarantee symmetric paper growth, paper must be taken from the center of the paper machine, so that it cannot be utilized to its full width, since a paper machine can have double the width of the machines used for further processing.

The method suggested according to the present invention, or the decorative paper according to the present invention can also achieve advantages in this context. By applying a suitable amount of the aliphatic, polycarbonate-containing anionic polyurethane dispersion, the paper growth can be reduced from currently 1.5% to almost 0. The aliphatic, polycarbonate-containing anionic polyurethane dispersion hardened after printing, fixes the paper width. Paper does no longer grow during impregnation.

Usually, the aliphatic, polycarbonate-containing anionic polyurethane dispersion is applied to the printed side. As the application “flatness” shows in an exemplary manner, application to the back of the paper can also be advantageous.

TABLE 1
SAFETY DATA SHEET

page 1 of 5

1. IDENTIFICATION OF THE SUBSTANCE/PREPARATION AND COMPANY/UNDERTAKING
BAYHYDROL XP 2606
Use:
Binder for coating materials
Bayer MaterialScience AG, HSEQ-PRC (Product Safety)
51368 Leverkusen, Germany, Tel: +49 214 30 25026
Fax: +49 214 30 50035, e-mail: productsafety@bayerbmaterialscience.com
Emergency Tel. No.: +49 214 30 99300 (Safety Center Bayer)
Address in Switzerland: Bayer MaterialScience, Bayer (Switzerland) AG
Grubenstr. 6, 8045 Zurich, phone: +41 1 465 8111, Fax: +41 1 462 0754
Emergency information (tox-center) Phone: +41 1 251 5151
2. COMPOSITION/INFORMATION ON INGREDIENTS
water-thinnable polyurethane dispersion
approx. 35% in water, (neutralized with approx. 1.35% N-ethyldiisopropylamine;
neutralising agent bound as a salt)
5-chloro-2-methyl-3(2H)-isothiazolone and 2-methyl-3(2H)-isothiazolone (3:1)
wt.-%: <0.0015

| | |
|---|---|
| CAS-No.: 55965-84-9 | Index-No.: 613-167-00-5 |

EG-No.: 247-500-7/220-239-6
Classification: T R23/24/25; C R34, R43; N R50/53
Specific threshold concentration

| | | | |
|---|---|---|---|
| Xi; | R 43 = | from | 0.0015% |
| Xi; | R 36/38-43 = | from | 0.0600% |
| Xi; | R 36/38-43-52/53 = | from | 0.2500% |
| C; | R 34-43-52/53 = | from | 0.6000% |
| C, N; | R 34-43-51/53 = | from | 2.5000% |
| C, N; | R 20/21/22-34-43-51/53 = | from | 3.0000% |
| T, N; | R 23/24/25-34-43-50/53 = | from | 25.0000% |

3. HAZARDS IDENTIFICATION
NON-HAZARDOUS according to the criteria of NOHSC NON-DANGEROUS GOODS
Not a product dangerous for health or the environment according to the definition of EC
Directives 67/548/EWG or 1999/45/EC.
4. FIRST AID MEASURES
General advice: Take off all contaminated or soaked clothing.
If inhaled and/or swallowed: In case of irritation of the respiratory tract or swallowing of the
product seek medical advice.
In case of skin contact: Wash off with soap and plenty of water (do not allow it to dry). Consult a
doctor in the event of a skin reaction.
In case of eye contact: Hold the eyes open and rinse with preferably lukewarm water for a
sufficiently long period of time (at least 10 minutes). Contact an ophthalmologist.

TABLE 2
SAFETY DATA SHEET

page 2 of 5

BAYHYDROL XP 2606
5. FIRE-FIGHTING MEASURES
Extinguishing media:
Carbon dioxide (CO2), foam, extinguishing powder, in cases of
larger fires, water spray jets should be used.
Firemen must wear self-contained breathing apparatus.
6. ACCIDENTAL RELEASE MEASURES
Put on protective equipment (see chapter 8). Ensure adequate
ventilation/exhaust extraction. Keep unauthorized persons away. Do not allow it to escape into
sewage system. Clean up with absorbents for chemicals or, if necessary with dry sand
and store in closed containers.
For further disposal measures see chapter 13.
7. HANDLING AND STORAGE
Handling: When handling observe the usual precautionary measures for chemicals. Ensure
sufficient ventilation, use extraction means if necessary, when handling and refilling product.
Storage: Keep container dry and tightly closed in a cold and well-ventilated place
VCI-storage class: 12
(VCI = Verband der Chemischen Industrie)
8. EXPOSURE CONTROLS/PERSONAL PROTECTION
If no air threshold value is specified here for substances named in chapter 2, then no threshold
value has been defined
Respiratory protection: Respiratory equipment required during spraying.
Hand protection:
Conditionally suitable materials for protective gloves; DIN EN 374-3:
Nitrile rubber - NBR; thickness: >=0.35 mm;
Breakthrough time: “Only suitable as splash protection.”
Only suitable for short term exposure. Dispose of protective gloves immediately after contamination.
Eye protection: Wear eye/face protection.
Skin and body protection: Wear suitable protective clothing.
Protective and Hygiene measures: Keep away from foodstuffs, drinks and tobacco. Wash hands
before breaks and at the end of workday. Keep working clothes separately. Change contaminated or
soaked clothing.

| 9. PHYSICAL AND CHEMICAL PROPERTIES | | | tested to |
|---|---|---|---|
| Form: | liquid | | |
| Colour: | off-white, cloudy | | |
| Odour: | slight inherent odour | | |
| Pour point: | 0° C. | | DIN ISO 3016 |
| Initial boiling point: | 89° C. | at 1.013 hPa | |
| Density: | 1.045 g/cm³ | at 20° C. | DIN 51757 |
| | | | (continued) |

TABLE 3
SAFETY DATA SHEET

page 3 of 5

BAYHYDROL XP 2606

| | |
|---|---|
| 9. PHYSICAL AND CHEMICAL PROPERTIES (continuation) | tested to |

| | | | |
|---|---|---|---|
| vapour pressure: | 29 hPa | at 20° C. | EG A4 |
| | 125 hPa | at 50° C. | EG A4 |
| | 156 hPa | at 55° C. | EG A4 |

| | | | |
|---|---|---|---|
| Viscosity, dynamic: | 58.2 mPa · s | at 20° C. | DIN 53019 |
| | | Shear gradient D = 561 s−1 | |

| | | |
|---|---|---|
| Flow time: | not applicable, thixotropic | DIN ISO 2431 |
| Solubility in water: | miscible | |

| | | |
|---|---|---|
| pH: | 8.0 | (Determined at 10% in H₂O) |

| Flash point: | No flash point up to initial boiling point | |
|---|---|---|
| Ignition temperature: | 425° C. | DIN 51794 |
| Further information: | | |

The indicated values do not necessarily correspond to the
product specification. Please refer to the technical information
sheet for specification data.
10. STABILITY AND REACTIVITY
Thermal decomposition: No thermal decomposition when stored and handled correctly.
Hazardous decomposition products: On drying of the coating/hardening release of
neutralising agent. (see chapter 2)
11. TOXICOLOGICAL INFORMATION
Toxicological studies on the preparation are not available.
If the usual precautionary and hygienic measures are observed when handling products of this
product group, no health hazards are known or to be expected
12. ECOLOGICAL INFORMATION
Do not allow to escape into waterways, wastewater or soil.
Eco-toxicological studies on the preparation are not available.
13. DISPOSAL CONSIDERATIONS
Dispose in accordance with applicable international, national and local laws, ordinances and
statutes.
For disposal within the EU, the appropriate code according to the European Waste Catalogue
(EWC) should be used.
After containers have been emptied as thoroughly as possible (e.g. by pouring, scraping or
draining until “drip-dry”), they can be sent to an appropriate collection point set up within the
framework of the existing take-back scheme of the chemical industry. Containers must be
recycled in compliance with national legislation and environmental regulations.
14. TRANSPORT INFORMATION
GGVSE. — UN: NODG PG: —
RID/ADR: — UN: NODG PG: —
ADNR: — UN: NODG PG: —
GGVSee/IMDG-Code: — UN: NODG PG: — MPO: NO
ICAO-TI/IATA-DGR: — UN: NRES PG: —

(continued)

TABLE 4
SAFETY DATA SHEET

page 4 of 5

BAYHYDROL XP 2606
14. TRANSPORT INFORMATION (continuation)
Declaration country: —
Declaration sea: —
Declaration air: —
Express goods Germany (acc. To GGVSE) approved: yes
Other information:
Not dangerous cargo. Slight smell. Avoid heat above +50° C.
Avoid temperatures below +5° C.
Keep separate from foodstuffs, drinks and tobacco.
15. REGULATORY INFORMATION
No labeling necessary according to the hazardous materials regulation and corresponding EC
Directives.
Operational safety regulations
Flammable liquids, not relevant.
(until 31.12.2002 VbF: not under VbF)
Technical regulations (TRbf) for flammable liquids are to be observed.
TA-Luft: With special applications, such as spraying or handling at high temperatures, relevancy to
the TA-Luft directive should be verified.
Water hazard class (WKG): 1 - low risk to water
(see Annex 4 VwVwS)
16. OTHER INFORMATION
All product components are listed in the European Inventory of Existing Commercial Chemical
Substances (EINECS) in accordance with legal requirements (EC guidelines, Chemicals Act).
Full text of R-phrases referred to under sections 2 and 3
R20/21/22: Harmful by inhalation, if swallowed and in contact with skin.
R23/24/25: Toxic by inhalation, if swallowed and in contact with skin.
R34: Causes burns.
R36/38: Irritates the eyes and skin
R43: May cause sensitization by skin contact.
R50/53 Very toxic to aquatic organisms, may cause long-term adverse effects in the
aquatic environment.
R51/53 Toxic to aquatic organisms, may cause long-term adverse effects in the
aquatic environment.
R52/53 Harmful to aquatic organisms, may cause long-term adverse effects in the
aquatic environment
The present Safety Data Sheet has been revised. Reason for revision: text changes (see chapters
2, 8, 9 and 16)

(continued)

TABLE 5
SAFETY DATA SHEET

page 5 of 5

BAYHYDROL XP 2606
16. OTHER INFORMATION (continuation)
This Safety Data Sheet replaces all previous editions.
Revised and valid from: See date of issue.
The indications are correct to the best of our knowledge and experience at the date of publication.
The Safety Data Sheet describes products with regard to security needs. The indications do not
have the meaning of statements about quality, assurances about characteristics or guarantees.

TABLE 6
Bayhydrol ® XP 2606

| Type | Aliphatic, anionic polyurethane dispersion containing polycarbonate; | | |
|---|---|---|---|
| | solvent-free | | |
| Form supplied | Approx. 35% in water, neutralized with N-ethyl diisopropylamine | | |
| | (bound as a salt) in proportion: approx. 35/64/1 | | |
| Uses | Binder for the production of water-reducible coatings for plastic | | |
| | substrates and wood materials. | | |
| Key Figures* | | | |
| Property | Value | Unit of measurement | Method |
| Non-volatile content | 34-36 | wt % | DIN EN ISO 3251 |
| (1 g/1 h/125° C. convection oven) | | | |
| Flow time at 23° C. | 12-60 | s | Bayer analysis |
| method | | | 2008-1050304 |
| (4 mm, 23°) | | | |
| Other data** | | | |
| Property | Value | Unit of measurement | Test method |
| pH | approx. 7-9 | | |
| Average particle size | 20-80 | nm | |
| Minimum film forming temp. | approx.. 45 | ° C. | |
| Viscosity at 23° C., | <100 | mPa · s | DIN EN ISO |
| 3219/A3 | | | |
| D = approx. 100/s | | | |
| Film properties: | | | |
| König pendulum hardness | approx. 140 | s | DIN 53 157 |
| Tear resistance | approx. 28 | N/mm² | DIN 53 455 |
| Elongation at break | approx. 180 | % | DIN 53 455 |

*These key figures are provisional, binding delivery tolerances are only given in the final data sheet.
**This is only general information

TABLE 7
Bayhydrol ® XP 2606

| | |
|---|---|
| Solubility/thinnability | The product is soluble in water. |
| Properties/Applications | The product was designed specifically for the coating of plastic |
| | substrates. In addition the use in the formulation of PVC floor |
| | coatings, the binder exhibits a high grade property profile on a variety |
| | of plastic substrates. Filler and topcoat applications (one and two- |
| | component) are also possible. Other possibilities are wood and |
| | furniture applications. |
| | Bayhydrol ® XP 2606 yields coatings with good leveling, chemical and |
| | weather stabilities. They are also characterized by a tough but flexible |
| | property profile. |
| | Very good combinations are possible with polyester, polyurethane |
| | and acrylic dispersions, but these must be checked on a case-by- |
| | case basis. Combinations with waterborne UV systems are also |
| | possible. Resistances can also be improved by post-curing with e.g. |
| | Bayhydur ® XP 2570. The mixing ratio of stock coating to hardener is |
| | generally 10: 1. |
| | Bayhydrol ® XP 2606 requires coalescing agents for film formation. |
| | Good results have been achieved with mixtures of butyl glycol/butyl |
| | diglycol/Dowanol ® TPnB (0.6:0.6:3.8). |

TABLE 8
Bayhydrol ® XP 2606

| | |
|---|---|
| Suitability for storage | In original sealed Bayer MaterialScience containers, at a temperature |
| | above freezing point and not above 40° C., the product can be stored |
| | for a period of approximately six months. |
| Safety | Hazards identificaion |
| | Not a product dangerous for health or the environment according to |
| | the definition of EC Directives 67/548/EWG or 1999/45/EG. |
| | Refer to Safety Data Sheet. It contains information on labeling, |
| | transport, storage as well as information on handling, product safety |
| | and ecology. |
| Important Note | This is a test product for which no conclusive data has been |
| | compiled. No guarantees can therefore be given for product behavior |
| | during processing and application. |

1-15. (canceled)

16. A method for producing decorative paper, which comprises the steps of:
printing a paper resulting in a printed paper; and
applying an aliphatic, polycarbonate-containing anionic polyurethane dispersion to the paper.

17. The method according to claim 16, which further comprises applying a resin to the printed paper after the aliphatic, polycarbonate-containing anionic polyurethane dispersion has been applied.

18. The method according to claim 16, wherein by applying the aliphatic, polycarbonate-containing anionic polyurethane dispersion, a pH value of 7-7.2 results on the printed paper.

19. The method according to claim 16, which further comprises mixing the aliphatic, polycarbonate-containing anionic polyurethane dispersion at a ratio of 25 parts to 75 parts water.

20. The method according to claim 16, which further comprises applying the aliphatic, polycarbonate-containing anionic polyurethane dispersion on top of the printed paper at a dry weight of about 5 g/m².

21. The method according to claim 16, which further comprises carrying out the applying of the aliphatic, polycarbonate-containing anionic polyurethane dispersion in a gravure printing process by means of background cylinders.

22. The method according to claim 16, which further comprises carrying out the applying of the aliphatic, polycarbonate-containing anionic polyurethane dispersion in a varnishing unit.

23. The method according to claim 16, which further comprises printing the paper with a metal effect ink.

24. The method according to claim 16, which further comprises applying the aliphatic, polycarbonate-containing anionic polyurethane dispersion to a non-printed side of the paper.

25. The method according to claim 16, which further comprises printing the paper with a TiO₂-containing ink.

26. The method according to claim 19, which further comprises providing Bayhydrol® XP 2606 as the aliphatic, polycarbonate-containing anionic polyurethane dispersion.

27. The method according to claim 20, which further comprises providing Bayhydrol® XP 2606 as the aliphatic, polycarbonate-containing anionic polyurethane dispersion.

28. The method according to claim 16, which further comprises carrying out the applying of the aliphatic, polycarbonate-containing anionic polyurethane dispersion in a gravure printing process by means of background cylinders, namely at a last printing unit one of online or offline.

29. The method according to claim 16, which further comprises printing the paper with a mother-of-pearl ink.

30. A decorative paper, comprising:
a paper core;
a printed layer; and
an aliphatic, polycarbonate-containing anionic polyurethane dispersion, embedded in said paper core.

31. The decorative paper according to claim 30, further comprising amino-plastic resins saturating said paper core with said printed layer.

32. The decorative paper according to claim 30, wherein:
said paper core is printed with said printing layer; and
said aliphatic, polycarbonate-containing anionic polyurethane dispersion is applied to at least one of said paper core or said printed layer.

33. The decorative paper according to claim 30, wherein said printed layer is formed of ink selected from the group consisting of a mother-of-pearl pigment-containing ink and TiO₂-containing ink.

34. The decorative paper according to claim 30, wherein said paper core is provided with the aliphatic, polycarbonate-containing anionic polyurethane dispersion layer on a side opposite said printed layer.
